(19) United States
(12) Patent Application Publication
(10) Pub. No.: US 2009/0250657 A1
(43) Pub. Date: Oct. 8, 2009

(54) Soil consolidation composition

(76) Inventor: Bo H. Gimvang, South Daytona, FL (US)

Correspondence Address: ROGERS TOWERS, P.A., 1301 RIVERPLACE BOULEVARD, SUITE 1500, JACKSONVILLE, FL, 32207, US

(21) Appl. No.: 12/381,831

(22) Filed: Mar. 17, 2009

Related U.S. Application Data
(60) Provisional application No. 61/037,289, filed on Mar. 17, 2008.

(51) Int. Cl. C09K 3/22

(52) U.S. Cl. 252/88.1

(57) ABSTRACT

A soil consolidation composition with a first part of an alkali metal silicate solution and a second part of a metal alcholate mixture. The alkali metal silicate of the first part is chosen from the group of alkali metal silicates including sodium, silicate, lithium silicate and potassium silicate, either individually or in combination. The metal alcholate mixture of the second part is a mixture of tri-acetine, di-acetine and tri-glycerol-di-acetine.

This application claims the benefit of U.S. Provisional Patent Application Ser. No. 61/037,289, filed Mar. 17, 2008, the disclosure of which is incorporated by reference herein.

### BACKGROUND OF THE INVENTION

This invention relates generally to the field of soil consolidation or binding compositions, and in particular for soil consolidation compositions useful in creating or repairing roads such that the soil after application of the composition is more readily compacted into a stable substrate capable of receiving vehicular traffic.

There is a need for an environmentally friendly substitute for the current road practices that use tar and aggregate to make roads for travel, or to repair existing roads. The present invention are compositions for binding or consolidation of dirt, clay, sand, or the like, to be referred to collectively herein as soil, whereby after application of the composition to the soil the soil is consolidated, compacted and hardened so as to be suitable for bearing the weight of vehicular traffic. The composition, being environmentally friendly, is very suitable for use in both developed and undeveloped countries. The composition is a two-part solution that is combined shortly prior to or simultaneously with application by spraying or similar method. As the composition dries, the soil is preferably compacted to better achieve a denser and harder substrate.

### SUMMARY OF THE INVENTION

The soil consolidation composition is a two-part solution that is combined shortly prior to or simultaneously with application to the soil to be consolidated, the composition consisting essentially of a first part of an alkali metal silicate solution and a second part of a metal alcholate mixture. The alkali metal silicate of the first part is chosen from the group of alkali metal silicates including sodium, silicate, lithium silicate and potassium silicate, either individually or in combination. The metal alcholate mixture of the second part consists essentially of a mixture of tri-acetine, di-acetine and tri-glycerol-di-acetine.

The composition is the combination of the first part and the second part, with the first part preferably present at approximately 70 to 95 wt. percent and the second part preferably present at approximately 30 to 5 wt. percent. The first part solution is preferably approximately 28 to 56 wt. percent silicate in water. The second part solution is preferably a mixture of approximately 2 to 10 wt percent tri-glycerol-di-acetine and approximately 98 to 90 wt. percent of a mixture of tri-acetine and di-acetine, with the tri-acetine present at approximately 30 to 70 wt. percent and the di-acetine present at approximately 70 to 30 wt. percent, most preferably with the tri-acetine and di-acetine present in equal amounts.

Upon combination of the first and second parts of the composition and application o the soil, consolidation will occur in a preferred range of 20 to 30 minutes. The consolidation or set-up time may be varied by adjusting the quantities of constituents of the second part. Thickeners, such as for example silica powder or silica flour, may be added to the composition to adjust its viscosity if needed. Other additives may be added to the composition so long as the additives do not cause a material change in the basic and novel characteristics of the invention relative to soil consolidation within a reasonable amount of time.

### DETAILED DESCRIPTION OF THE INVENTION

The soil consolidation composition is a two-part solution that is combined shortly prior to or simultaneously with application to the soil to be consolidated, the composition consisting essentially of a first part of an alkali metal silicate solution and a second part of a metal alcholate mixture, whereby a curing or hardening reaction occurs after application of the composition to soil, with the composition acting as a binding agent. In this sense, the term soil is taken to comprise any dirt, sand, clay or like material. After application of the composition to the soil, the soil may be compacted using known methods and equipment in order to produce a denser substrate to receive other layers of road material or to be used as the primary road surface for vehicular traffic.

The alkali metal silicate solution of the first part is chosen from the group of alkali metal silicate solutions including sodium silicate, lithium silicate and potassium silicate. The alkali metal silicates may be used individually or in combination. The metal alcholate mixture of the second part consists essentially of a solution of tri-acetine, di-acetine and tri-glycerol-di-acetine. The tri-acetine component is an extremely fast curing agent, the di-acetine is an extremely slow curing agent, and the tri-glycerol-di-acetine is a suitable control curing agent. Varying the wt. percentages of these components alters the curing time of the composition.

The composition is the combination of the first part and the second part, with the first part preferably present at approximately 70 to 95 wt. percent and the second part preferably present at approximately 30 to 5 wt. percent. The first part solution is preferably approximately 28 to 56 wt. percent silicate in water. The second part solution is preferably a mixture of approximately 2 to 10 wt percent tri-glycerol-di-acetine and approximately 98 to 90 wt. percent of a mixture of tri-acetine and di-acetine, with the tri-acetine present at approximately 30 to 70 wt. percent and the di-acetine present at approximately 70 to 30 wt. percent, most preferably with the tri-acetine and di-acetine present in equal amounts.

Upon combination of the first and second parts of the composition and application o the soil, consolidation will occur in a preferred range of 20 to 30 minutes, which as indicated above can be shortened or lengthened by adjusting the relative amounts of the tri-acetine and di-acetine. Increasing the wt. percentage of tri-acetine shortens the cure time, while increasing the wt. percentage of di-acetine lengthens the cure time.

Additives, such as for example silica powder or silica flour in an amount from trace to approximately 5 wt. percent, may be added to the composition to adjust its viscosity if needed, although excessive use of thickening additives may preclude application by spraying, which is typically the most efficient application method. Other additives may be added to the composition so long as the additives do not cause a material change in the basic and novel characteristics of the invention relative to achieving soil consolidation within a reasonable amount of time.

It is contemplated that certain equivalents or substitutions for certain elements set forth above may be obvious to one skilled in the art, and therefore the true scope and definition of the invention is to be as set forth in the following claims.

I claim:

1. A soil consolidation composition, said composition being a binding agent for soil such that upon application of said composition said soil consolidates into a hardened substrate, said composition consisting essentially of:
a first part of alkali metal silicate solution and a second part of metal alcholate mixture, whereby curing occurs upon mixing of said first part and said second part.

2. The composition of claim 1, said composition having approximately 70 to 95 wt. percent of said alkali metal silicate solution and approximately 30 to 5 wt. percent of said metal alcholate mixture.

3. The composition of claim 2, wherein said alkali metal silicate solution is chosen from the group of alkali metal silicate solutions including sodium silicate, lithium silicate and potassium silicate, individually or in combination, and wherein said metal alcholate mixture consists essentially of a solution of tri-acetine, di-acetine and tri-glycerol-di-acetine.

4. The composition of claim 3, wherein said alkali metal silicate solution consists essentially of 28 to 56 wt. percent silicates in water.

5. The composition of claim 3, said metal alcholate mixture having approximately 2 to 10 wt. percent tri-glycerol-di-acetine and approximately 98 to 90 wt. percent of a mixture of tri-acetine and di-acetine.

6. The composition of claim 5, said mixture of tri-acetine and di-acetine having approximately 30 to 70 wt. percent of tri-acetine and approximately 70 to 30 wt. percent di-acetine.

7. The composition of claim 5, said mixture of tri-acetine and di-acetine having approximately 50 wt. percent of tri-acetine and approximately 50 wt. percent di-acetine.

8. The composition of claim 4, said metal alcholate mixture having approximately 2 to 10 wt. percent tri-glycerol-di-acetine and approximately 98 to 90 wt. percent of a mixture of tri-acetine and di-acetine.

9. The composition of claim 8, said mixture of tri-acetine and di-acetine having approximately 30 to 70 wt. percent of tri-acetine and approximately 70 to 30 wt. percent di-acetine.

10. The composition of claim 8, said mixture of tri-acetine and di-acetine having approximately 50 wt. percent of tri-acetine and approximately 50 wt. percent di-acetine.

11. A soil consolidation composition, said composition being a binding agent for soil such that upon application of said composition said soil consolidates into a hardened substrate, said composition consisting of:
a first part of alkali metal silicate solution and a second part of metal alcholate mixture, whereby curing occurs upon mixing of said first part and said second part.

12. The composition of claim 11, said composition consisting of approximately 70 to 95 wt. percent of said alkali metal silicate solution and approximately 30 to 5 wt. percent of said metal alcholate mixture.

13. The composition of claim 12, wherein said alkali metal silicate solution is chosen from the group of alkali metal silicate solutions including sodium silicate, lithium silicate and potassium silicate, individually or in combination, and wherein said metal alcholate mixture consists of a solution of tri-acetine, di-acetine and tri-glycerol-di-acetine.

14. The composition of claim 13, wherein said alkali metal silicate solution consists of 28 to 56 wt. percent silicates in water.

15. The composition of claim 13, said metal alcholate mixture consiting of approximately 2 to 10 wt. percent tri-glycerol-di-acetine and approximately 98 to 90 wt. percent of a mixture of tri-acetine and di-acetine.

16. The composition of claim 15, said mixture of tri-acetine and di-acetine consisting of approximately 30 to 70 wt. percent of tri-acetine and approximately 70 to 30 wt. percent di-acetine.

17. The composition of claim 15, said mixture of tri-acetine and di-acetine consisting of approximately 50 wt. percent of tri-acetine and approximately 50 wt. percent di-acetine.

18. The composition of claim 14, said metal alcholate mixture consisting of approximately 2 to 10 wt. percent tri-glycerol-di-acetine and approximately 98 to 90 wt. percent of a mixture of tri-acetine and di-acetine.

19. The composition of claim 18, said mixture of tri-acetine and di-acetine consiting of approximately 30 to 70 wt. percent of tri-acetine and approximately 70 to 30 wt. percent di-acetine.

20. The composition of claim 18, said mixture of tri-acetine and di-acetine consiting of approximately 50 wt. percent of tri-acetine and approximately 50 wt. percent di-acetine.
